(19) United States
(12) Patent Application Publication
(10) Pub. No.: US 2011/0192824 A1
(43) Pub. Date: Aug. 11, 2011

(54) LASER WELDING OF HIGHLY REFLECTIVE MATERIALS

(75) Inventors: Anders Vestergaard, Sydals (DK); Jia He, Beijing (CN); Bingyuan Huang, Tianjin (CN); Youdong Pi, Beijing (CN)

(73) Assignee: DANFOSS A/S

(21) Appl. No.: 12/673,245

(22) PCT Filed: Aug. 15, 2008
(86) PCT No.: PCT/DK08/00289

§ 371 Date: Dec. 1, 2010

(30) Foreign Application Priority Data
Aug. 17, 2007 (DK) PA 2007 001176

(51) Int. Cl. B23K 26/00

(52) U.S. Cl. 219/121.64

(57) ABSTRACT

The invention concerns a method of welding two metal parts together. The first part and the second part are made of metal or metal alloys and the reflectivity of the first part is lower than or equal to the reflectivity of the second part. Typically the first part is made of brass and the second part is made of copper. In the common welding zone, the less reflective part covers the most reflective part, so the laser beam is directed only against the less reflective part. The advantage of this is that the laser beam is not directly in contact with the high reflective part so less energy is reflected away from the welding zone.

### CROSS REFERENCE TO RELATED APPLICATIONS

This application is entitled to the benefit of and incorporates by reference essential subject matter disclosed in International Patent Application No. PCT/DK2008/000289 filed on Aug. 15, 2008 and Danish Patent Application No. PA 2007 01176 filed Aug. 17, 2007.

### TECHNICAL FIELD

The invention concerns a method of welding two metal parts together of which one part has a high reflectivity.

### BACKGROUND OF THE INVENTION

Laser welding of Stainless steel was introduced in the late 1980 and resistance (projection) welding of complex metal combinations was introduced during the 1990. Traditionally the joining process of copper, brass and tin bronze for decades has been brazing. The process is well proven and robust but has the disadvantage of entirely heating of the product and the use of a brazing material and protection gas. Logistic wise the freedom is low because this process will often have to be first in a production and will name the product early. Critical tolerances are often to be adjusted after brazing due to heat distortion and the successive assembly of internal additional parts will have to follow late in the production process. The potential advances with changing from brazing (furnace or induction) to laser welding can be summarised as:

Quality: The strength in the copper and brass material are kept.
Environmental: The energy demanded is lower, and environment impact is lower.
Logistic: The joining can be made all places in the production flow.
Cost: Faster process, lower energy, no washing, no bright dipping, no brazing material (silver) and no flux material,

During the 1990 several attempts to make a robust laser welding of the copper and brass parts were carried out but it always failed in the industrial environment due to low robustness.

In the Danfoss patent application WO2006069576A1 a laser welding process is described where two parts are welded together and the laser beam is transmitted in a direction from a laser source and at least partly into a gap between the two parts. The gap captures the beam so it is not reflected away and also the gap serves as a gap for welding vapours to diffuse away.

The method in Danfoss patent application WO2006069576A1 does not work well when one of the parts is very highly reflective, for instance if one of the parts are made of copper. If the laser beam is not controlled extremely well, the beam can reflect of the highly reflective part, and hence not transfer enough energy the welding zone to cause a stabile welding.

DE10346264A1 describes a method to weld two parts together by laser welding where the first part covers the second part and there is a recess wherein the welding takes place. The purpose of the recess is to bring the two parts together.

For metals with very high reflectivity laser welding normally cannot be used. Highly reflective materials are assembled in conventional processes by brazing because the high reflectivity makes welding ineffective.

### SUMMARY OF THE INVENTION

In this invention the problem of laser welding on highly reflective materials is solved by joining a first part and a second part together by laser welding, the first part and the second part are made of metal or metal alloys and the reflectivity of the first part is lower than or equal to the reflectivity of the second part. The first part is placed so it partly covers the second part creating an overlap zone, and in the overlap zone by directing a laser beam against the surface of the first part, the first part and the second part is joined together by creating a common welding zone. The first part comprises a recess and the laser beam is during welding mainly directed into the recess and the laser beam is at least partly captured in the recess.

The first part is placed so it overlaps the second part and a laser is directed against the surface of the first part creating a common welding zone where the laser beam melts through the first part and into the second part.

The less reflective part covers the most reflective part so the laser beam is directed against the less reflective part. The advantage of this is that the laser beam is not directly in contact with the high reflective second part so less energy is reflected away from the welding zone. The less reflective part can be made of brass and the second part can be made of copper. Utilising the brass as cover gives the beam the necessary good start, once the process has started the brass melts and transferring heat into the second part so the second part in the welding zone also melts and the first part melts into the second part creating a high quality welding.

Further improvement is achieved by the recess. The recess is made in the less reflective part to capture the beam so it is not reflected away. This keeps the energy of the beam in the recess and heats up the metal more efficient.

In DE10346264A1 the recess is wide and does not capture the laser beam. The recess in this invention is narrow and therefore captures the beam meaning that the reflections of the beam mainly stay in the recess and contributes heating up the welding zone.

The recess narrows down towards the bottom in a cone shape. The cone is pointed so there is no flat bottom but the cone can have a rounded tip. The cone shape is an advantage to keep the reflections in the recess where a flat bottom would make it easier for reflections to reflect out of the recess. When there is no flat bottom the reflected beam will be deflected and hit the side wall of the recess and dispose further energy to heat up the welding zone.

The recess is less than 1 mm wide; the narrow recess makes it possible to capture most of the beam inside the recess.

Using an infrared laser for welding in copper based alloys imply to overcome the high reflectivity of the material. Obviously a normal surface weld with an angle of incidence of 0 degrees is difficult due to more than 95% reflectivity. It is a big advantage to establish a recess which traps the beam by multiple reflections and corresponding vapour/plasma absorption.

A gap can be made between the first part and the second part to allow vapours resulting from the welding process to diffuse through the gap away from the welding zone. Typically the first part is made of a brass alloy containing materials typically zinc having a lower boiling point than the average boiling point of the alloy. This creates vapours during welding when the zinc starts to boil, so the gap allows these vapours to diffuse away from the welding zone. The advantage is that the vapours do not disturb or contaminate the welding zone obtaining a more homogeneous weld.

Brass consists of several low boiling alloys of which zinc is the most important with regard to welding. The zinc vapour absorbs the light making a good coupling to the material—on the other side it also disturbs the stability of the process due to the recoil forces during evaporation. The welding process is stabilised by the “escape” gap designed in to the parts to be welded allowing the vapours to diffuse away.

The first part is typically made of a brass alloy with a lower reflectivity than for instance copper, the second part is typically made of a copper or a copper rich alloy. Normally it is not possible to weld on a high reflective material like copper but covering the copper part by the brass part so the laser beam only is in contact with the brass part makes welding with a high reflective material like copper possible.

The first part typically is 0.7-1.5 mm thick. During the welding process the first part is melted all the way through and melts into the second part. If the first part is too thick it will take longer time to melt through the first part and into the second part and the penetration depth into the second part will be smaller resulting in a less stabile weld. Further more if the first part is to thin the zinc will burn out of the Brass making the brass part to weak. The welding gives the best results in the middle of the mentioned thickness interval, especially in the interval 0.9-1.2 mm.

The best results is obtained with the welding speed is between 10-40 mm/s and the laser power between 2-3 kW or with a welding speed between 40-70 mm/s the laser power is between 3-4 kW. These parameters are found by test and are resulting in the optimal welding quality.

Using the optimal welding parameters like beam splitting, power, speed and welding geometry further improves the welding process.

### BRIEF DESCRIPTION OF THE DRAWINGS

FIG. 1 shows a view of the welding process in this invention.

FIG. 2 shows an example how to use this process welding a copper tube into a brass part.

FIG. 3a-e shows five different geometries for FIG. 1 for the use of this invention.

FIG. 4 is a diagram showing depth and width of weld for different welding speed.

FIG. 5 is a diagram showing weld depth and width as a function of brass thickness.

FIG. 6 is a diagram showing power and welding speed relationship.

### DETAILED DESCRIPTION OF THE PREFERRED EMBODIMENTS

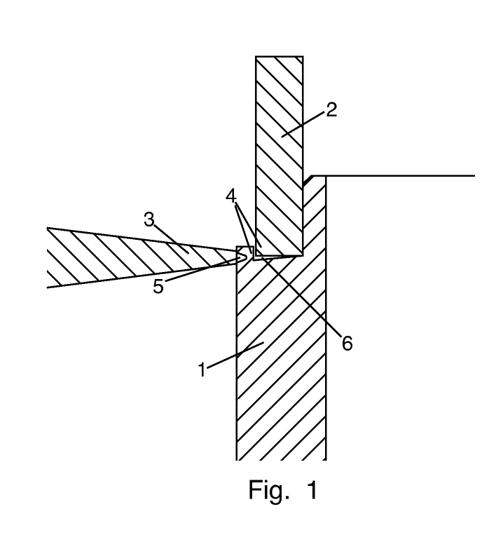

FIG. 1 shows the principle in this welding method comprising a laser beam 3 directed against the first part 1 with the lowest reflectivity typically made of brass covering the second part 2 with has the highest reflectivity and is typically made of copper. The first part 1 and the second part 2 are placed so there is an overlap zone where the first part 1 covers the second part 2. The welding takes place in a common welding zone 4, against which the laser beam 3 is directed and welds the first part 1 and the second part 2 together. Welding vapours diffuse away through a gap 6.

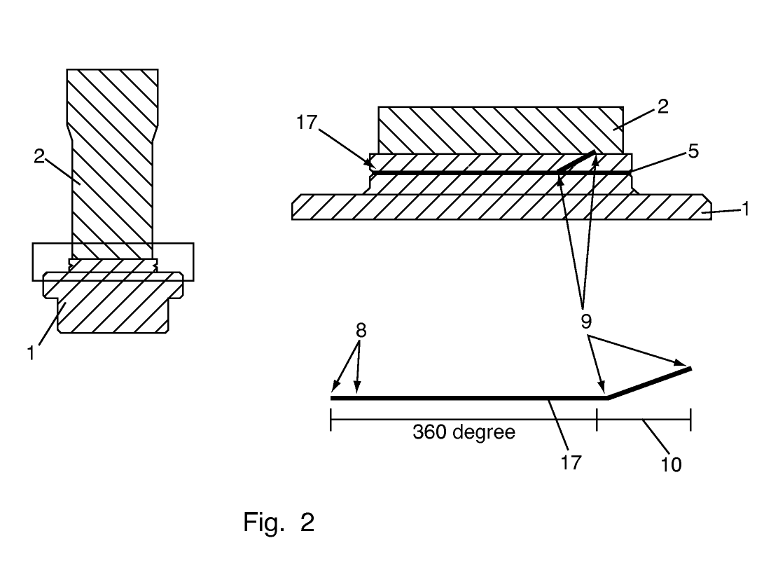

FIG. 2 shows the second part 2, a copper tube, welded on to the first part 1, a brass part. A recess 5 on the first part 1 captures the laser beam 17 all the way 360 degrees around the first part 1. When the welding process starts there is a ramping up period 8 and when the welding process ends there is a ramping down period 9. During the ramping down period there is an overlap 10. During ramping down 9 the laser beam 17 can be moved up away from the recess 5 into the part of the first part 1 that covers the second part 2 because during ramping down 9 the laser beam 17 can make holes in the first part 1 so the ramping down 9 takes place in material that covers the second part 2 so holes in the first part 1 doesn't matter.

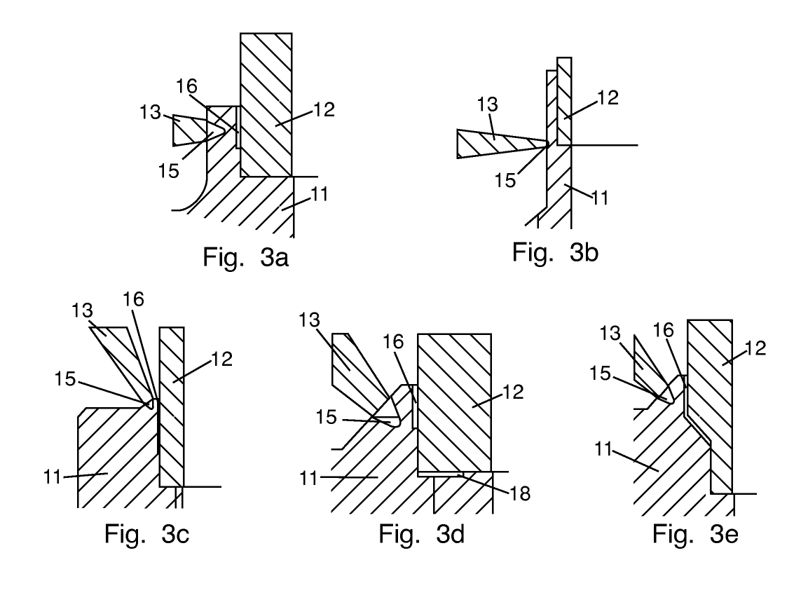

FIG. 3a-e shows five different embodiments of the process. FIG. 3a-e comprising a brass part 11 and a copper part 12, the brass part 11 comprises a recess 15 that captures the laser beam 14. The recess 15 is placed in the welding zone 14. There is a gap 16 between the brass part 11 and the copper part 12 where vapours resulting from the welding process can move away from the welding area. FIG. 3b-3e is different embodiments of FIG. 3a with a few differences. FIG. 3b has no gap 16 and FIG. 3d has an extra gap 18 where melt from the welding can pass into. In FIG. 3c-e the welding angle is more oblique.

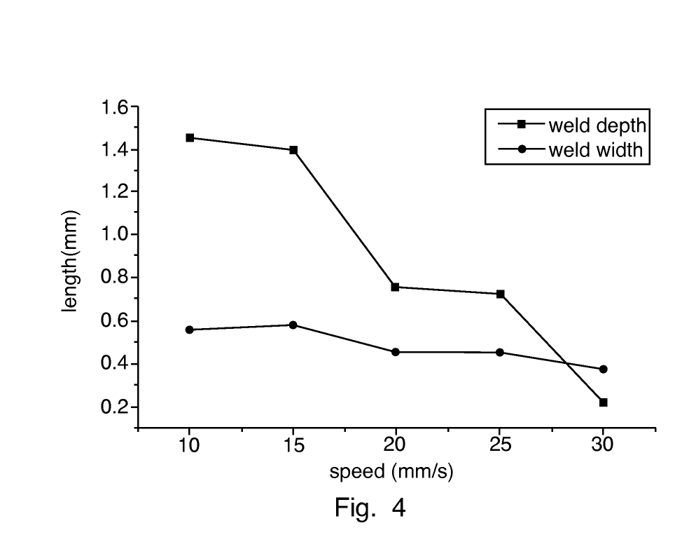

FIG. 4 shows the relationship between the welding depth, width and welding speed in a test with a 2 kW laser. It is obvious that the welding depth decreases with increasing welding speed. There is no clear change to welding width.

In a test made with a 2 kW laser the speed is optimised with regard to obtain the optimum linear energy (energy/mm). When the speed is 10 mm/s, the linear energy is too high to get smooth surface because of instabilities in the welding pool. The welding seam stability becomes better when the speed increases to 15 mm/s and 20 mms/s. At 25 mm/s there are white substances on welding seam surface which are found to be Zinc deposits.

At 4 kW laser power the available speed range is found to be in the interval between 40 to 70 mm/s. Qualitatively the same welding results appear as for the 2 kW ie. low speed leads to a burn of the brass and were as the high speed limit is determined by to low penetration into the copper.

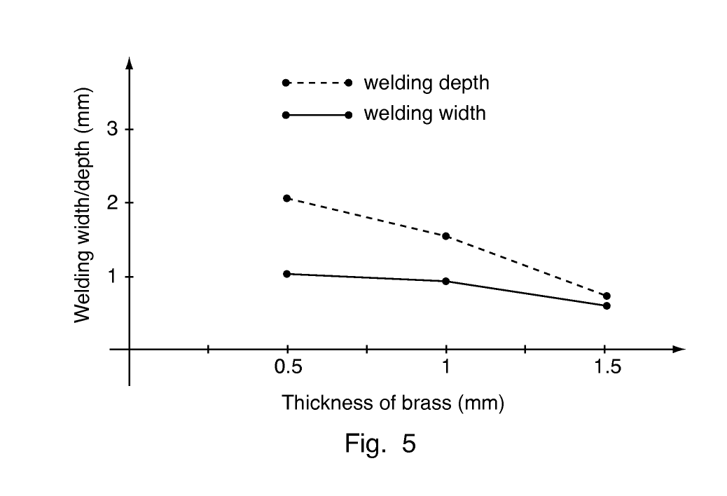

FIG. 5 shows the relationship between welding seam parameter and thickness. For 4 kW laser power 0.5, 1 and 1.5 mm brass were tested. The thickness of the brass part covering the copper tube is an important parameter to observe. The appearances of the welding seams are similar as the welding width only increases a little with the increasing of brass thickness. From the grindings it appears how the welding depth is affected by the thickness of brass ie. the thinner the brass, the deeper the welding depth.

TABLE 1
the bursting pressure for each test

| 2 kW | | | | | | | | | | 4 kW | | | |
|---|---|---|---|---|---|---|---|---|---|---|---|---|---|
| Thickness of | | | | | Welding speed | | | | | Thickness of | | Welding speed | |
| brass(mm) | | | | | (mm/s) | | | | | brass(mm) | | (mm/s) | |
| Speed = 20 mm/s | | | | | Thickness = 1.1 mm | | | | | Speed = 40 mm/s | | Thickness = 1 mm/s | |
| Tₖ | 0.9 | 1 | 1.1 | 1.2 | 10 | 15 | 20 | 25 | 30 | 1 | 1.5 | 40 | 50 |
| Pₕ | 211 | 247 | 258 | 225 | 220 | 245 | 255 | 220 | 185 | 300 | 255 | 300 | 290 |

Table 1 shows the bursting pressure for each test. To evaluate the welding quality a burst test is performed. 10 pieces of each welding parameter are chosen for average bursting test results.

From Table 1, 2 kW laser power: The highest bursting pressure is up to 255 bar for 20 mm/s while 180 bar for 30 mm/s and 220 bar for 10 mm/s. The high welding speed can not reach satisfied welding strength due to low welding depth. Low welding speed leads to too high linear energy which burn out the zinc of the welding seam making the brass part to weak. The thickness of the brass also has an influence on the burst test. The medium size (1.1 mm) has the highest bursting pressure at 258 bar. The 0.9 mm brass bursts at 211 bar (to little remaining material) and the 1.2 mm brass bursts at 225 bar (to little power left for the copper part.

From Table 1, 4 kW laser power: 1 mm thickness gives highest burst pressure. Lowering the weld speed gives the burst pressure of 300 bar—far exceeding the necessary limit. This means the speed can be increased to benefit the productivity. The laser beam is double spot meaning a wider weld seam. This definitely increases the bonding area in the weld seam. A 2 kW power would not succeed in having a split beam due to the insufficient power density.

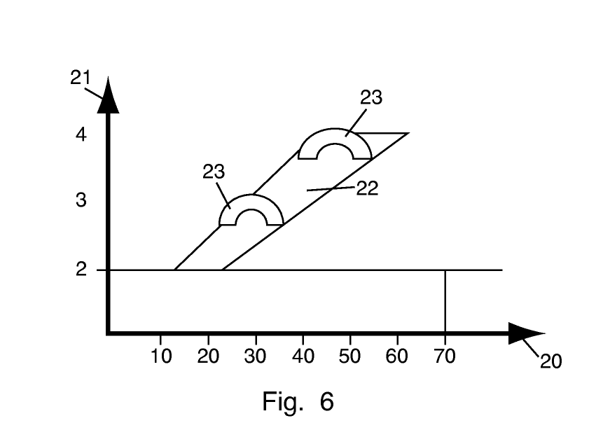

FIG. 6 shows laser power and welding speed relationship found in a test. The x-axis 20 shows welding speed [mm/s] and the y-axis 21 shows laser power [kW]. Below 2 kW there is no data. In the diagram in FIG. 6 is marked a stable process area 22, in this area the welding process is stable. On the right side of the area 22 when the welding speed increases, there is low penetration depth and the recess can collapse and the welding is therefore not stable enough. On the left side of the area 22 when the welding speed is low the melt become unstable and the zinc in the brass can burn off and weaken the strength of the brass. The experiments show that optimising the process is a question of balancing the heat input together with the welding speed and material dimensions. The brass part needs to have a certain thickness to remain sufficiently after the beam has passed—however—a too thick brass overlap will only decrease maximum speed. The arcs 23 in FIG. 6 indicate that the best results with the optimum weld strength are achieved in the middle of the area 22.

High speed is good for the welding stability but only until a certain point where the heat balance for maintaining the recess can not be kept any longer. The demands to the strength of the weld (225 bar in burst pressure) means that a certain penetration (plus width) into the copper is necessary. In this case the power is limiting factor. Higher would probably mean higher speed.

The laser power determines the welding speed which is applicable for obtaining a good welding seam quality. In FIG. 6 the relation between best welding speed and power is shown as a linear dependence. It will cause welding defects such as non-weld area or cracks if the welding speed not matches the laser power.

The conclusions are
1. The optimal welding seam parameters providing good leak and burst test results are shown in the table below.

TABLE 2
welding seam geometries

| Welding depth (mm) | Welding width (mm) |
|---|---|
| 1.7 | 1 |

2. There is an approximately linear relationship between the laser power and the best welding speed. The weld appearance for low power and low speed is however different to the high power and high speed.

TABLE 3
welding speed and laser power

| | Laser power | | |
|---|---|---|---|
| | 2 KW | 3 KW | 4 KW |
| Welding speed (mm/s) | 15 | 30 | 45 |

3. Using a laser power of 4 kW a piping diameter of 28 mm can withstand a pressure of up to 300 bar.

While the present invention has been illustrated and described with respect to a particular embodiment thereof, it should be appreciated by those of ordinary skill in the art that various modifications to this invention may be made without departing from the spirit and scope of the present.

What is claimed is:

1-12. (canceled)

13. A method of joining a first part and a second part together by laser welding, the first part and the second part are made of metal or metal alloys and the reflectivity of the first part is lower than or equal to the reflectivity of the second part wherein the first part is placed so it covers the second part in an overlap zone, and in the overlap zone by directing a laser beam against the surface of the first part, the first part and the second part is joined together by creating a common welding zone, the first part comprises a recess and the laser beam during welding mainly is directed into the recess and the laser beam is at least partly captured in the recess, the recess narrows down towards the bottom of the recess in a cone shape.

14. The method according to claim 13, wherein the recess is less than 1 mm wide.

15. The method according to claim 13, wherein there is a gap between the first part and the second part and vapours resulting from the welding process diffuse away from the welding zone through the gap.

16. The method according to claim 13, wherein the first part is made of a brass alloy.

17. The method according to claim 13, wherein the second part is made of a copper or a copper rich alloy.

18. The method according to claim 13, wherein the thickness of the first part in the overlap zone is 0.7-1.5 mm thick.

19. The method according to claim 13, wherein the thickness of the first part in the overlap zone is 0.9-1.2 mm thick.

20. The method according to claim 13, wherein the welding speed is 10-40 mm/s

21. The method according to claim 13, wherein the laser power is 2-3 kW.

22. The method according to claim 13, wherein the welding speed is 40-70 mm/s

23. The method according to claim 13, wherein the laser power is 3-4 kW.
